(19) United States
(12) Patent Application Publication
(10) Pub. No.: US 2023/0367086 A1
(43) Pub. Date: Nov. 16, 2023

(54) OPTICAL MODULE

(71) Applicant: OPTIWORKS (KUNSHAN) CO., LTD., Kunshan City (CN)

(72) Inventors: Chun Lun YEH, Kunshan City (CN); Pin Ru LIN, Kunshan City (CN)

(73) Assignee: OPTIWORKS (KUNSHAN) CO., LTD., Kunshan City (CN)

(21) Appl. No.: 18/140,959

(22) Filed: Apr. 28, 2023

(30) Foreign Application Priority Data
May 11, 2022 (CN) 202210511178.7

(51) Int. Cl. G02B 6/42

(52) U.S. Cl. CPC G02B 6/4251

(57) ABSTRACT

The present invention discloses an optical module which includes a circuit board, a wire end connector, a board end connector and a sealing cover. The board end connector has a reflective interface and is fixed on the circuit board. The wire end connector is connected with the board end connector. The sealing cover is disposed over the circuit board and covers at least a portion of the board end connector and at least a portion of the wire end connector. The reflective interface on the board end connector is completely accommodated in the sealing cover. End faces of the sealing cover are sealed. The disclosed optical module is easily sealed, requires a small amount of sealant and is reworkable.

### CROSS-REFERENCE TO RELATED APPLICATIONS

This application claims the priority of Chinese patent application number 202210511178.7, filed on May 11, 2022, the entire contents of which are incorporated herein by reference.

### BACKGROUND OF THE INVENTION

An optical module is an optoelectronic device that performs optical-electro and electro-optical conversions. Its transmitting end converts an electrical signal into an optical signal, and its receiving end converts an optical signal into an electrical signal. An optical module generates heat during operation. As the power consumption of an optical module increases, traditional air-cooling systems can no longer meet the cooling requirements of the optical module. In recent years, a new technology of immersing the optical module in an insulating liquid for cooling has become a development trend. The accompanying problem is how to seal the optical module to prevent cooling liquid from entering through a gap to cause interruption of light transmission.

Chinese patent publication number CN110716269A discloses an optical module that is capable of adopting liquid immersion cooling and a manufacturing method thereof. The module includes an injection molding housing that fully encloses a PCB, a photoelectric device, an optical lens, an optical connector and other components. The module can be used for a long time in a liquid immersion environment and achieves complete isolation of the photoelectric device inside the module from the external liquid, effectively preventing the cooling liquid from contaminating the optical components in the optical module and interfering with the optical path. However, there is a problem of inability to rework.

Another known design is shown in FIG. 1, in which an anti-permeation film 22 is first aligned and attached to an opening on a reflective interface 21 of a board end connector 2, and then a large amount of sealant 5 is directly poured over two connectors 2 and 3 to completely close any gaps G between the two connectors 2 and 3 so as to achieve the effect of waterproofing. However, it also has the disadvantage of inability to rework. In addition, the operation of attaching the anti-permeation film 22 to the opening on the reflective interface 21 of the board end connector 2 involves procedures requiring high precision such as gluing, alignment, and flat pressing, so it must be performed manually, resulting in an increased cost.

In the prior art, when injection molding is used to mold a plastic housing or when a large amount of sealant is poured over an optical module, the circuit board, optoelectronic device, optical lens, and optical connector are covered with sealant, and the sealant fills gaps between the components. When the optical module is subjected to a test and found to have been failed due to fiber breakage, etc., as the gaps G between the components have been filled with sealant and the components are tightly connected, the broken fiber cannot be replaced from the product. The whole product has to be replaced, resulting in a high cost.

Furthermore, assembly workshop and injection workshop are usually two separate spaces. An assembled optical module needs to be transported from the assembly workshop to the injection workshop for injection molding. And the injection molding requires the purchase of additional high-cost equipment such as injection molds and robots. Besides, the design of the anti-permeation film is also costly, rendering the total production cost very high.

### SUMMARY OF THE INVENTION

In order to overcome the defects in the prior art, in an embodiment of the present invention, an optical module is provided, which has the advantages of being easily assembled, reworkable, and having good waterproof effect.

The optical module of this embodiment has the advantages of being easy to manufacture and being reworkable. More specifically, the sealing cover in the optical module of this embodiment is used to seal the reflective interface on the board end connector and the wire end connector. The sealing cover is sealed through coating soft sealant at edges between the sealing cover and the board end connector and circuit board, and by interference fit with the wire end connector. Only a small amount of sealant is needed to achieve waterproof against cooling liquid. The sealant coating process is simple and can be directly carried out on the assembly line, which omits the transportation of the assembled products, saves production time and production costs. Moreover, due to the design of the extension portion, the alignment and fixation of an anti-permeation film can be omitted. Just a small amount of soft sealant applied between the sealing cover and the board end connector can ensure the sealing, and the sealant can be easily removed completely. Therefore, when the optical fiber is broken and functions abnormally, the sealing cover can be removed just by removing the sealant. After the sealing cover is removed, the wire end connector and the board end connector can be non-destructively plugged and unplugged, so that the optical module can be reworked and the product needs not be discarded.

In order to make the above-mentioned and other objectives, features and advantages of the present invention more obvious and easy to understand, preferred embodiments are exemplified below and are described in detail in conjunction with the accompanying drawings.

### BRIEF DESCRIPTION OF DRAWINGS

FIG. 1 is a schematic diagram showing a large amount of sealant poured over two connectors according to the prior art.

FIG. 2 is a schematic structural diagram of an optical module in an embodiment of the present invention.

FIG. 3 is a schematic structural diagram showing the connection between a wire end connector, a board end connector and a circuit board in an embodiment of the present invention.

FIG. 4 is a schematic structural diagram of a sealing cover mounted on the circuit board viewed from a first angle according to an embodiment of the present invention.

FIG. 5 is a schematic structural diagram of the sealing cover mounted on the circuit board viewed from a second angle according to an embodiment of the present invention.

FIG. 6 is a schematic structural diagram of the sealing cover from a first viewing angle in an embodiment of the present invention.

FIG. 7 is a schematic structural diagram of the sealing cover from a second viewing angle in an embodiment of the present invention.

FIG. 8 is a schematic structural diagram of the sealing cover from a third viewing angle in an embodiment of the present invention.

FIG. 9 is a schematic structural diagram of the connection between a clamping member and the board end connector and the wire end connector in an embodiment of the present invention.

FIG. 10 is a schematic structural diagram of the clamping member in an embodiment of the present invention.

In the figures: 1—circuit board; 2—board end connector; 21—reflective interface; 22—anti-permeation film; 3—wire end connector; 31—first part; 32—second part; 4—sealing cover; 41—main body; 411—top plate; 412—bottom plate; 413—left wing; 414—right wing; 42—extension portion; 4A—rear end opening; 4B—front end opening; 4C—lower side opening; 4D—channel; 5—sealant; 6—clamping member; 61—first bending portion; 62—second bending portion; 7—upper casing; 8—lower casing; G—gap.

### DETAILED DESCRIPTION OF THE INVENTION

For a better understanding of the above objectives, features and advantages of the present invention, reference is made to the following description of specific embodiments thereof, taken in conjunction with the accompanying drawing. These drawings are all simplified schematic diagrams, which are provided merely to illustrate the basic structure of the present invention and thus show only the components related to the invention. It is to be noted that embodiments of the present application and features of the embodiments may be combined if there is no conflict therebetween.

In the description herein, the use of the terms “first”, “second” and the like herein is intended for illustration only and is not to be construed as denoting or implying relative importance or as implicitly indicating the numerical number of the referenced item. Accordingly, defining an item with “first”, “second” or the like is an explicit or implicit indication of the presence of one or more of the items. In the description herein, unless otherwise specified, the meaning of “plurality” is two or more.

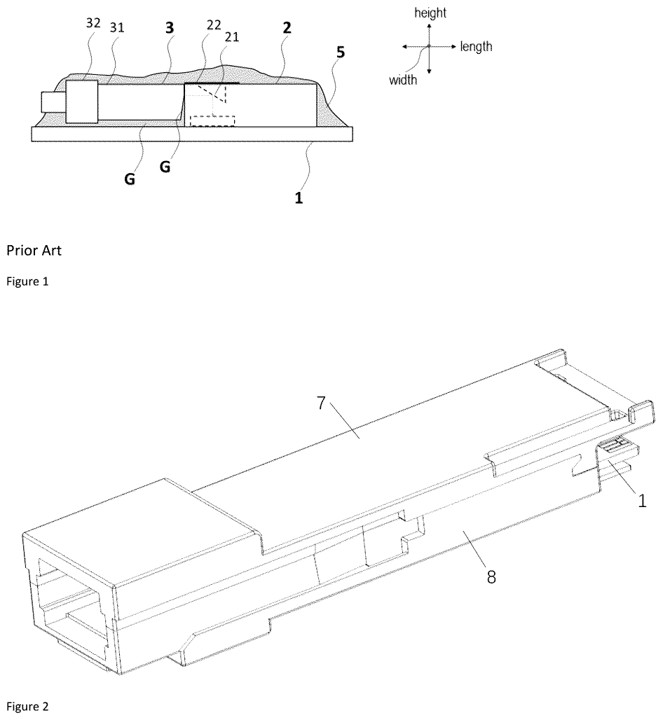

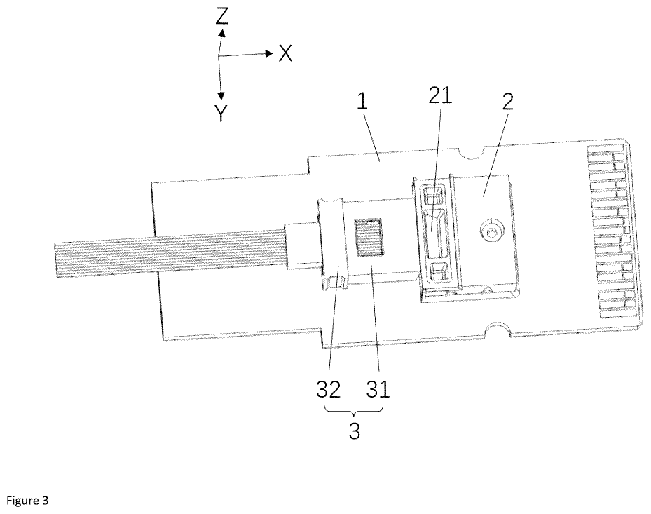

As shown in FIGS. 2 to 5, the optical module of this embodiment is an optical module that is able to be used with liquid immersion cooling, and more specifically, it is a Quad Small Form-factor Pluggable (QSFP) connector that is able to be used with liquid immersion cooling.

In this embodiment, the optical module mainly includes assembly components such as a circuit board 1, a wire end connector 3, a board end connector 2, a sealing cover 4, an upper casing 7 and a lower casing 8. Here, the term assembly component means a part or a component that has been fabricated in advance and is then attached or assembled to another part or component by adhesive or through a coupling mechanism. An element, such as an injection molding film, that is coated or directly formed over surface of other components to couple the components together, is not an assembly component because it is not fabricated in advance and then assembled. The term “coat” means forming a layer of material on a surface regardless of the thickness thereof or filling a material into a space.

The upper casing 7 and the lower casing 8 match each other and are connected to form a cavity for accommodating the circuit board 1 and other components. Both side walls of each of the upper casing 7 and the lower casing 8 are provided with transverse grooves for accommodating components such as a handle and a fastener. It should be noted that, in this embodiment, the design of handle, fastener, etc. does not affect the main effect of the present invention, so the handle, fastener, etc. are not shown in the figure. In practical application, the optical module of this embodiment needs to be equipped with handle, fastener or other components like the ones shown in CN110716269A.

The circuit board 1 is fixed in the lower casing 8 and a portion of the circuit board 1 extends outside the cavity. A working surface of the circuit board 1 is provided with a light sensing chip for receiving and transmitting optical signals and a light output chip.

The board end connector 2 is fixed on the circuit board 1 and covers both the light sensing chip and the light output chip. The upper surface of the board end connector 2 is provided with a groove, and a reflective interface 21 is arranged in the groove. The reflective interface 21 is configured to reflect light from the wire end connector 3 to the light sensing chip. The reflective interface 21 is also configured to reflect light from the light output chip to an optical fiber cable in the wire end connector 3. The aforementioned reflective interface 21 may be a total internal reflective interface.

One end of the wire end connector 3 is connected to the board end connector 2, and the other end is equipped with the optical fiber cable that extends out of the cavity formed between the upper casing 7 and the lower casing 8.

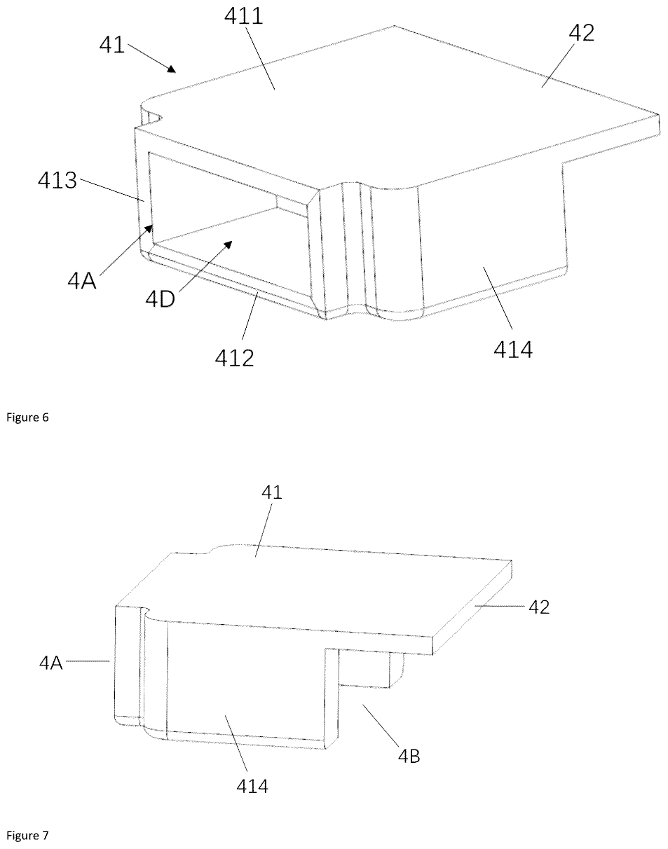

As shown in FIG. 6, the sealing cover 4 is a pre-formed and integrally formed assembly component. The sealing cover 4 can be made of rubber, and more specifically, can be made of silicone rubber. However, the material of the sealing cover 4 is not limited to this. Any other material that can provide slight elastic deformation and waterproof can be used. In addition, the Shore hardness of the material of the sealing cover 4 is between 55D and 95D, and more preferably, the Shore hardness of the material of the sealing cover 4 is about 85D. Such material ensures the sealing cover 4 to fill, upon compression, the gaps between connection interfaces among components. A material that is too hard or too soft may affect the sealing performance of the sealing cover 4.

As shown in FIGS. 6 and 7, the sealing cover 4 includes a main body 41 and an extension portion 42 that are integrally formed. The main body 41 can be divided into several portions, namely a top plate 411, a bottom plate 412, a left wing 413 and a right wing 414. The left wing 413 and the right wing 414 are disposed between the top plate 411 and the bottom plate 412. Both the top plate 411 and the bottom plate 412 extend from a rear end to a front end of the main body 41. A lengthwise (X direction) dimension of the top plate 411 is larger, while a central portion of the bottom plate 412 is shorter. When the main body 41 is disposed on a surface (e.g., a surface of the circuit board), it can form, together with the surface, a rectangular channel 4D running in a direction from the rear end to the front end. The channel 4D has a front end opening 4B and a rear end opening 4A. The front end opening 4B is close to the board end connector 2, and the rear end opening 4A is farther away from the board end connector 2. A side of the channel 4D close to the rear end opening 4A is narrower, and a side of the channel 4D close to the front end opening 4B is wider, thereby forming a step-like structure.

As shown in FIG. 8, since the bottom plate of the main body 41 is short, the bottom side of the main body has a lower side opening 4C. In other words, the side (bottom) of the main body 41 facing the surface (such as the circuit board) may also be provided with a lower side opening 4C, which can reduce the material of the sealing cover 4 to save cost and reduce the fabrication complexity. It should be noted that the size of the lower opening 4C is preferably within a certain range to ensure a sufficient contact area between the sealing cover 4 and the circuit board 1 to ensure the sealing performance between the sealing cover 4 and the circuit board 1. More specifically, by assuming a horizontal area of the lower side opening 4C as A and the maximum horizontal area of an upper surface of the main body 41 as B, then a ratio of A/B in a range of between 20% and 80% is more suitable to achieve both waterproofing performance and manufacturability.

The relative relationship of the components will be described below. In this embodiment, the extension portion 42 of the sealing cover 4 is formed extending from the top plate of the main body 41 in a direction from a rear end toward a front end. The extension portion 42 is in the shape of a rectangular sheet. The main body 41 has a profile with a narrow rear portion and a wide front portion. The outer dimension of the narrow rear portion is slightly larger than the outer dimension of the wire end connector 3, while the height and width of an end face of the wide front portion are only slightly larger than or substantially the same as the outer dimension of the board end connector 2.

During assembly, the wire end connector 3 is pressed into the channel 4D of the sealing cover 4 from the rear end opening (first opening) 4A and is exposed from the front end opening (second opening) 4B. The wire end connector 3 has an interference fit with the rear end opening 4A, and the sealing cover 4 made of rubber material has a certain elasticity, so the channel 4D can hold the wire end connector 3 tightly, thereby sealing the sealing cover 4 and the wire end connector 3. A sealant 5 may be optionally provided or omitted between the channel 4D of the sealing cover 4 and the wire end connector 3. In this example, the sealant 5 is omitted.

After assembly, the wire end connector 3 is held on the circuit board 1 by the main body 41, and the sealing cover 4 covers at least a portion of the board end connector 2 and at least a portion of the wire end connector 3. All end faces of the sealing cover 4 can optionally be sealed with a small amount of waterproof sealant. At the same time, the reflective interface 21 on the board end connector 2 and the connection interface between the board end connector 2 and the wire end connector 3 are completely accommodated in the sealing cover 4 to ensure that the optical performance of the reflective interface 21 is not affected. Compared with the conventional design which requires an additional anti-permeation film 22, the design of the sealing cover 4 of this embodiment eliminates the alignment step for manually assembling the anti-permeation film 22, and hence reduces assembly difficulty and cost.

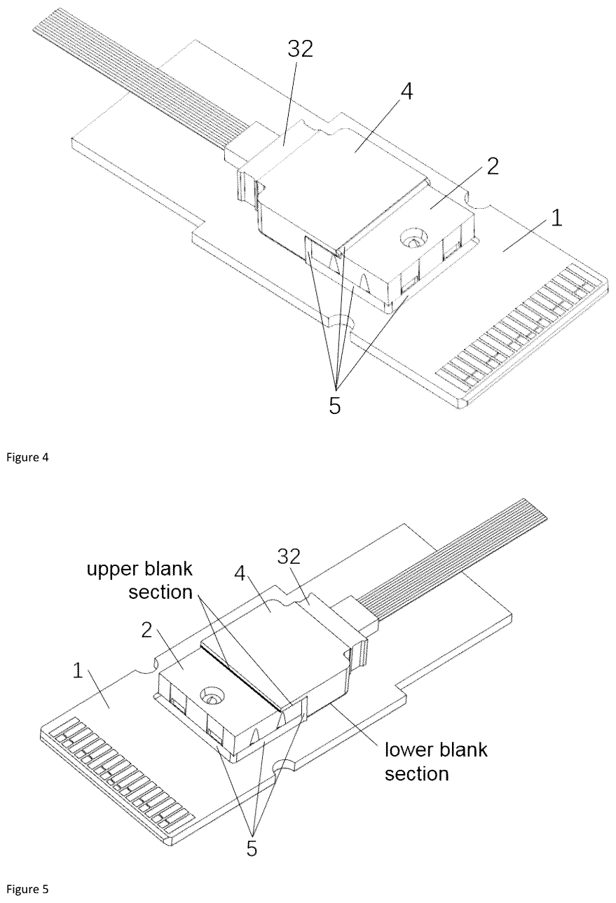

As shown in FIG. 5, in this embodiment, a lower blank section may be provided between the main body 41 of the sealing cover 4 and the circuit board 1. In the lower blank section, the sealing cover 4 abuts against the circuit board 1 and therefore it is not necessary to use sealant 5 to completely seal them. In other words, in the lower blank section, even if no sealant 5 is provided between the sealing cover 4 and the circuit board 1, the sealing and waterproofing between the two can be achieved. In this embodiment, the sealant 5 is used for sealing between the outer edge of the extension portion 42 of the sealing cover and the board end connector 2. In other embodiments, an upper blank section may be provided at the outer edge of the extension portion 42, and in the upper blank section, the extension portion 42 of the sealing cover 4 abuts against the board end connector 2 and it is not necessary to use sealant 5 to completely seal them. In other words, in the upper blank section, even if no sealant 5 is provided between the extension portion 42 of the sealing cover 4 and the board end connector 2, sealing and waterproofing between the two can be achieved.

In addition, the thickness of the bottom plate 412 of the sealing cover 4 just fills the gap between the wire terminal connector 3 and the circuit board 1. That is, the bottom plate 412 is arranged between the terminal connector 3 and the circuit board 1. As shown in FIG. 3, the wire end connector 3 of this embodiment includes a first part 31 accommodated in the sealing cover 4 and a second part 32 arranged outside the sealing cover 4. The second part 32 has dimensions in the X and Z directions respectively larger than dimensions in the X and Z directions of an end portion of the sealing cover 4 at the rear end opening 4A. In this way, the end portion of the sealing cover 4 and the second part 32 of the wire end connector 3 can abut against each other, which is beneficial to improve the tightness of the connection between the wire end connector 3 and the sealing cover 4.

As shown in FIGS. 4, 5 and 8, a strip of sealant 5 can be provided at each connection interface between the board end connector 2 and the circuit board 1. The sealant 5 is selected as a soft adhesive with better sealing performance. End faces 413A and 414A of the left wing 413 and right wing 414 facing the board end connector 2 respectively abut against end faces of the board end connector 2 facing the wire end connector 3 or in direct contact therewith. Here, A abuts against B means that one of A and B exerts a pressure on the other, and is not limited to a direct contact between A and B. A further material (such as sealant 5) can be arranged between A and B. Sealant 5 can be provided between the board end connector 2 and the circuit board 1. The vertical interfaces between the two end faces 413A, 414A and the board end connector 2 can also be sealed with a strip of sealant 5 as shown in FIG. 4 to prevent liquid from entering.

In order to ensure that the sealing cover 4 can cover the reflective interface 21 of the board end connector 2, extension portion 42 is provided at the side of the sealing cover 4 away from the circuit board 1 and is in contact with the end face of the front end opening 4B. With this configuration, a coverage area of the sealing cover 4 over the board end connector 2 is reduced on the premise of satisfying the sealing of the board end connector 2, so that the material of the sealing cover 4 can be reduced, and thermal performance of the board end connector 2 is improved.

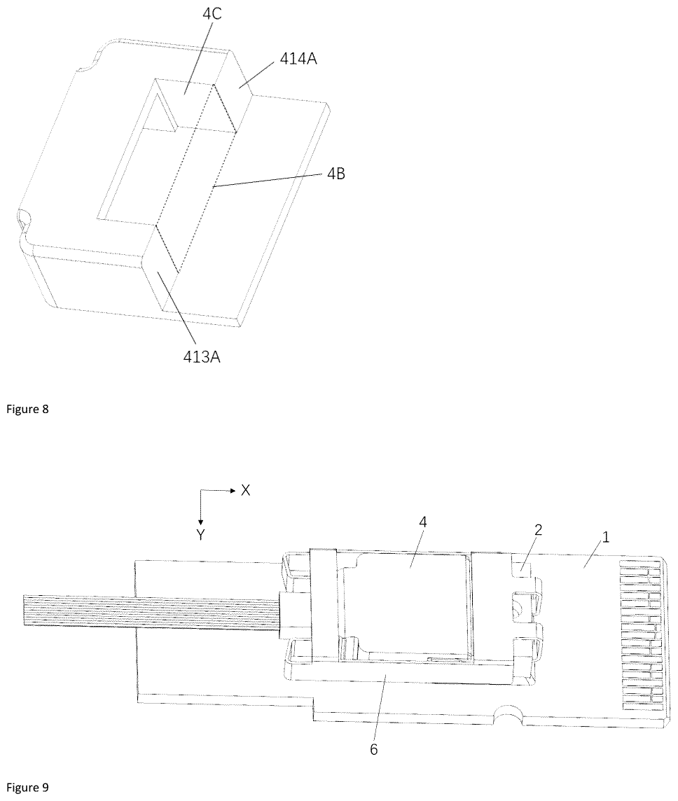

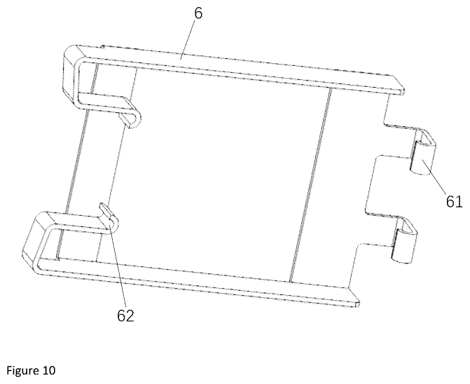

Further, as shown in FIGS. 9 and 10, the optical module of this embodiment may further include a clamping member 6 disposed above the sealing cover 4. One end of the clamping member 6 is provided with a first bending portion 61, and the other end is provided with a second bending portion 62. The first bent portion 61 is used to abut against the end of the board end connector 2 that faces away from the wire end connector 3, and the second bent portion 62 is used to abut against the end of the wire end connector 3 that faces away from the board end connector 2. On the one hand, the clamping member 6 can improve the pressing force of the sealing cover 4 along the X direction, which is beneficial to improve its sealing performance, and on the other hand, the clamping member 6 can also prevent a jumper from falling off.

Preferably, a spacer (not shown) with a certain elasticity is optionally disposed between the sealing cover 4 and the upper casing 7 to connect the upper casing 7 and the sealing cover 4. When the upper casing 7 is assembled with the lower casing 8, the upper casing 7 applies a pressure to the sealing cover 4 to press it tightly on the board end connector 2. That is, the upper casing 7 presses and holds the sealing cover 4 to ensure that the upper casing 7 is pressed tightly to prevent external objects such as the cooling liquid from entering the optical port. The above-mentioned spacer may be integrated in the upper casing 7 or in the sealing cover 4. That is, the side of the upper casing 7 facing the sealing cover 4 can be provided with a protruding structure, or, a portion of or the entire upper side of the sealing cover 4 can be thickened to prevent loosen of the sealing cover 4 after the upper casing 7 and the lower casing 8 are assembled. Since the top plate of the sealing cover 4 is pressed by the upper casing 7 against the wire end connector 3 and the board end connector 2, there is no need to apply sealant 5 between the top plate of the sealing cover 4 and the connectors 3 and 2 to maintain a sealed state. With this configuration, when the wire end connector 3 needs to be separated from the board end connector 2 due to rework of the optical module, the worker can hold and lift the top plate of the sealing cover 4 to remove and peel off the sealing cover 4 from the wire end connector 3 and the board end connector 2. When peeling off, the sealant between the sealing cover 4 and the board end connector 2 will be pulled away from the circuit board 1 and the optical module can be directly reworked without further cleaning the residual sealant in most cases. As the sealant is soft and slender, it will not damage other components when it is pulled away, and even if there is residual sealant, it can be directly scraped off with a tool, which is extremely simple.

In addition, there is an opening between the upper casing 7 and the circuit board 1 and/or between the lower casing 8 and the circuit board 1, and the opening can allow the cooling liquid to enter a cavity formed by the upper casing 7 and a housing to contact the circuit board 1, so as to improve the heat dissipation efficiency of the circuit board 1.

The preparation method of the optical module in this embodiment is generally as follows: firstly, the board end connector 2 is fixed or welded on the circuit board 1, and in this step, a gap between the board end connector 2 and the circuit board 1 can be coated with a sealant 5; then, the sealing cover 4 is assembled on the circuit board 1 by well aligning the sealing cover 4 with the board end connector 2 and applying sealant 5 at the connection interface between the sealing cover 4 and the board end connector 2; afterward, the wire end connector 3 is inserted into the sealing cover 4 from the rear end opening 4A and connected to the board end connector 2. Alternatively, the wire end connector 3 can be inserted into the sealing cover 4 first, and then the sealing cover 4 and the board end connector 2 are aligned and fixed on the circuit board 1.

In short, one important aspect of an embodiment of the present invention is the design of the sealing cover 4. An objective of the present invention is to design a configuration which can prevent liquid from entering a connection interface between the wire end connector 3 and the board end connector 2 or entering the groove on the top of the board end connector 2. For the connection interface, the sealing cover 4 is sleeved over the end portion of the wire end connector 3; when the wire end connector 3 is pushed towards the board end connector 2, the front end face of the sealing cover 4 will be clamped between the wire end connector 3 and the board end connector 2, so as to constitute an anti-seepage structure. As for the groove of the board end connector, the extension portion 42 of the sealing cover 4 covers the entire groove of the board end connector, and the downward pressure exerted by the upper casing 7 prevents the infiltration of liquid. At the same time, when the sealing cover 4 is pressed, it will be pressed on the circuit board 1, which further prevents the cooling liquid from infiltrating the connection interface through a gap between the circuit board 1 and the wire end connector 3, so that the conventional method of adopting an anti-permeation film 22 can be omitted.

In the present invention, the principles and implementations of the present invention are described by using specific embodiments, and the descriptions of the above embodiments are only used to help understand the method and the core idea of the present invention. The idea of the invention will have changes in the specific implementation and application scope. To sum up, the content of this specification should not be construed as a limitation to the present invention.

1. An optical module, comprising:
a circuit board;
a wire end connector;
a board end connector, having a reflective interface and being fixed on the circuit board, wherein the wire end connector is connected with the board end connector; and
a sealing cover, which is an assembly component,
wherein the sealing cover includes a main body and an extension portion that are integrally formed, wherein the main body is assembled to an end portion of the wire end connector, and the extension portion extends from the main body toward the board end connector, and
wherein the extension portion covers the reflective interface to isolate the reflective interface from an external space.

2. The optical module according to claim 1, wherein the main body of the sealing cover is in a shape of a hollow ring and is provided with a channel, the channel having a front end opening and a rear end opening, wherein the wire end connector is inserted into the main body through the rear end opening and is fixed in the channel, and wherein the wire end connector is in an interference fit with the rear end opening of the channel.

3. The optical module according to claim 2, further comprising a sealant coated over a connection interface between the board end connector and the circuit board, where the connection interface is not covered by the sealing cover.

4. The optical module according to claim 3, wherein the sealing cover has two side walls at the front end opening, and a vertical interface between each of the side walls and the board end connector is filled with a strip shaped sealant.

5. The optical module according to claim 4, wherein a lower blank section is provided between the main body of the sealing cover and the circuit board, wherein in the lower blank section, the sealing cover is configured to abut against the circuit board and a connection interface between the sealing cover and the circuit board is not completely sealed by a sealant.

6. The optical module according to claim 5, wherein the sealing cover is integrally formed with a material having a Shore hardness of 55-95D.

7. The optical module according to claim 6, wherein an end face of the sealing cover at the front end opening is configured to abut against an end face of the board end connector.

8. The optical module according to claim 7, wherein an upper blank section is provided at an outer edge of the extension portion, wherein in the upper blank section, the extension portion of the sealing cover is configured to abut against the board end connector and a connection interface between the extension portion and the board end connector is not completely sealed by a sealant, and wherein the sealing cover is provided with a lower side opening on a side thereof facing the circuit board.

9. The optical module according to claim 1, further comprising a clamping member disposed over the sealing cover, one end of the clamping member abutting against an end of the board end connector away from the wire end connector, another end of the clamping member abutting against an end of the wire end connector away from the board end connector.

10. The optical module according to claim 1, further comprising a lower casing disposed under the circuit board and an upper casing disposed above the sealing cover, wherein when the upper casing is connected with the lower casing, the upper casing exerts a pressure against the sealing cover.
